(19) United States
(12) Patent Application Publication
(10) Pub. No.: US 2017/0292212 A1
(43) Pub. Date: Oct. 12, 2017

(54) Method for Manufacturing Metal Staple Fibers and Apparatus for Manufacturing Metal Staple Fibers

(71) Applicant: 3M INNOVATIVE PROPERTIES COMPANY, St. Paul, MN (US)

(72) Inventors: Yoshiyuki Ohkura, Tokyo (JP); Nobuaki Ando, Kanagawa (JP)

(21) Appl. No.: 15/529,586

(22) PCT Filed: Nov. 18, 2015
(86) PCT No.: PCT/US2015/061244

§ 371 Date: May 25, 2017

(30) Foreign Application Priority Data
Nov. 28, 2014 (JP) 2014-241562

(51) Int. Cl. D06B 9/06; C08L 27/12; B26D 7/08; B26D 1/06; D06M 15/70; D02G 3/12

(52) U.S. Cl. CPC D06B 9/06; D06M 15/70; D02G 3/12; B26D 7/088; B26D 1/065; C08L 27/12

(57) ABSTRACT

Problem: To provide a method for manufacturing metal staple fibers that allows for the efficient manufacture of uniform metal staple fibers. Solution: A method for manufacturing metal staple fibers including a cutting step of cutting a metal fiber bundle coated with a fluorine-based polymer into a staple fiber bundle.

### FIELD OF THE INVENTION

The present invention relates to a method for manufacturing metal staple fibers and an apparatus for manufacturing metal staple fibers.

### BACKGROUND ART

Conventionally, metal fibers have superior properties such as strength, wear resistance, heat resistance, and high electrical conductivity, and are widely used as long fibers or staple fibers.

Metal staple fibers are manufactured by forming metal fibers into a bundle shape to prepare rigid bundles of metal fibers, and cutting the bundles of metal fibers into shorter pieces. For example, patent document 1 discloses a method of manufacturing pellets of a feedstock material for molding an electromagnetic shield housing by applying a mixed solution of polystyrene and a styrene-based thermoplastic elastomer to metal fiber bundles manufactured by a coil cutting method, then removing the solvent in the mixed solution to gather the metal fiber bundle together, and cutting the bundle to a predetermined length.

Patent document 2 discloses a method of cutting metal fibers by impregnating a metal fiber bundle with water to create a water-impregnated metal fiber bundle, then freezing the water-impregnated metal fiber bundle in a cooling atmosphere to create a frozen metal fiber bundle, after which the frozen metal fiber bundle is cut short to form frozen metal staple fiber bundles.

### PRIOR ART DOCUMENTS

Patent Document 1: Unexamined Japanese Patent Application Publication No. H05-318467
Patent Document 2: Unexamined Japanese Patent Application Publication No. H08-243990

### SUMMARY OF THE INVENTION

### Problem to be Solved by the Invention

The manufacturing method disclosed in patent document 1 yields metal staple fibers contained within pellets; however, it is difficult to remove only the metal staple fibers from the pellets, and the applications for which the fibers can be used in pellet form are limited. Meanwhile, the manufacturing method disclosed in document 2 requires a cooling device for freezing the water-impregnated metal fiber bundle, leading to the problem of increased manufacturing costs.

An object of the present invention is to provide a method for manufacturing metal staple fibers that allows for the efficient manufacture of uniformly cut metal staple fibers by suppressing bundle collapse when cutting metal fiber bundles. Another object of the present invention is to provide an apparatus for manufacturing metal staple fibers that allows for the efficient manufacture of uniformly cut metal staple fibers.

### Means for Solving the Problem

One aspect of the present invention relates to a method for manufacturing metal staple fibers. This manufacturing method includes a cutting step of cutting a metal fiber bundle coated with a fluorine-based polymer into a staple fiber bundle.

In one aspect, the fluorine atom content of the fluorine-based polymer may be at least 40% by mass of the total mass of the fluorine-based polymer.

In one aspect, the manufacturing method may further include a coating step of impregnating a metal fiber bundle with a coating fluid containing the fluorine-based polymer, and coating the metal fiber bundle with the fluorine-based polymer.

In one aspect, the manufacturing method may further include a removal step of using a fluorine-based solvent to dissolve and remove at least some of the fluorine-based polymer coating the staple fiber bundle.

In one aspect, some or all of the fluorine-based polymer removed in the removal step can be reused to coat metal fiber bundles in the manufacturing method.

Another aspect of the present invention relates to an apparatus for manufacturing metal staple fibers. The manufacturing apparatus is provided with a coating mechanism for coating a metal fiber bundle with a fluorine-based polymer, and a cutting mechanism for cutting the metal fiber bundle coated with the fluorine-based polymer into staple fiber bundles.

In one aspect, the coating mechanism may include a coating tank for storing a coating fluid containing the fluorine-based polymer, and a conveying means for passing the metal fiber bundle through the coating tank so that the coating fluid impregnates the metal fiber bundle.

In one aspect, the manufacturing apparatus may be further provided with a removal mechanism for using a fluorine-based solvent to dissolve and remove at least some of the fluorine-based polymer coating the staple fiber bundle.

In one aspect, the removal mechanism may immerse the staple fiber bundle in the fluorine-based solvent to dissolve at least some of the fluorine-based polymer.

In one aspect, the manufacturing apparatus may be further provided with a recovery mechanism for recovering the fluorine-based polymer removed by the removal mechanism.

### Effect of the Invention

In accordance with the present invention, it is possible to provide a method for manufacturing metal staple fibers that allows for the efficient manufacture of uniformly cut metal staple fibers by suppressing bundle collapse when cutting metal fiber bundles. In accordance with the present invention, it is also possible to provide an apparatus for manufacturing metal staple fibers that allows for the efficient manufacture of uniformly cut metal staple fibers.

### BRIEF DESCRIPTION OF THE DRAWINGS

FIG. 1 is a schematic illustration of an embodiment of an apparatus for manufacturing metal staple fibers according to the present invention.

### BEST MODE FOR CARRYING OUT THE INVENTION

A preferred embodiment of the present invention will be described below.

### (Method for Manufacturing Metal Staple Fibers)

The manufacturing method according to the present embodiment includes a cutting step of cutting a metal fiber bundle coated with a fluorine-based polymer into a staple fiber bundle.

In the manufacturing method according to the present embodiment, it is possible to prevent bundle collapse during cutting by coating the metal fiber bundle to be cut with a fluorine-based polymer. It is thus possible to obtain uniformly cut staple fiber bundles in the cutting step.

The metal fiber bundle is obtained by bundling metal fibers. There is no particular limitation upon the material, fiber diameter, and the like of the metal fibers; these can be selected, as appropriate, according to the desired metal staple fibers. There is likewise no particular limitation upon the cross-sectional shape, bundle diameter, bundle fiber count, and the like of the metal fiber bundle; these can be adjusted as appropriate according, for example, to the type of manufacturing apparatus used (especially the cutting mechanism).

Examples of the material of the metal fibers include stainless steel such as SUS 304 or SUS 316, copper, aluminum, titanium, or the like. The fiber diameter of the metal fibers may be, for example, 0.001 mm or greater, 0.01 mm or greater, and 0.1 mm or less, or 0.5 mm or less.

The cross-sectional shape of the metal fiber bundle may be, for example, circular, elliptical, roughly rectangular, or the like. The bundle diameter of the metal fiber bundle may be, for example, 1 to 10 mm or 2 to 5 mm in terms of a diameter corresponding to a circle of equal area. The bundle fiber count of the metal fiber bundle may be, for example, 400 to 1,000,000, or 900 to 250,000.

The fluorine-based polymer is a resin containing fluorine atoms. The fluorine-based polymer preferably functions as a binder for the metal fiber bundle, and imparts rigidity so that the metal fiber bundle can easily be cut as an integrated whole. In the manufacturing method according to the present embodiment, coating with this type of fluorine-based polymer suppresses collapse of the metal fiber bundle during cutting, allowing for uniform cutting.

Fluorine-based polymers are known to have a lower coefficient of friction than, for example, other thermoplastic resins. Thus, in the manufacturing method according to the present embodiment, it is hypothesized that frictional drag between the cutting blade and the cutting surface during cutting of the staple fiber bundle is reduced, thereby minimizing warping of the cut section.

The fluorine atom content of the fluorine-based polymer is preferably 40% by mass or greater with respect to the total amount of fluorine-based polymer, and is more preferably 45% by mass or greater. Such a fluorine-based polymer is capable of yielding especially low frictional drag between the cutting blade and the cutting surface of the metal fiber bundle, and tends to facilitate further removal and reuse using the fluorine-based solvent to be described hereafter. The fluorine atom content is preferably 70% by mass or less, and is more preferably 76% by mass or less.

There is no particular limitation upon the type of fluorine-based polymer used; various types of fluorine-based polymers can be applied. For example, the fluorine-based polymer may include a constituent unit represented by the following formula (1).

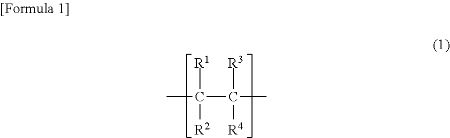

In the formula, R¹, R², R³, and R⁴ each independently represents a hydrogen atom, a fluorine atom, a chlorine atom, an alkyl group, a fluorinated alkyl group, an alkoxy group, or a fluorinated alkoxy group. At least one of R¹, R², R³ and R⁴ is a fluorine atom, a fluorinated alkyl group, or a fluorinated alkoxy group.

In formula (1), a preferred alkyl group is an alkyl group having 1 to 6 carbon atoms, more preferably having 1 to 3 carbon atoms, and still more preferably having 1 or 2 carbon atoms. A fluorinated alkyl group is an alkyl group for which some or all of the hydrogen atoms are substituted by fluorine atoms. In formula (1), the fluorinated alkyl group preferably has 1 to 6 carbon atoms, and more preferably 1 to 3 carbon atoms.

In formula (1), the alkoxy group is preferably an alkoxy group having 1 to 6 carbon atoms, and more preferably 1 to 3 carbon atoms. A fluorinated alkoxy group is an alkoxy group for which some or all of the hydrogen atoms are substituted by fluorine atoms. In formula (1), the fluorinated alkoxy group preferably has 1 to 6 carbon atoms, and more preferably 1 to 3 carbon atoms.

The fluorine-based polymer may be a polymer of a monomer group including a fluorine-based monomer that forms the constituent unit represented by formula (1). Examples of fluorine-based monomers that form the constituent unit represented by formula (1) include tetrafluoroethylene, chlorotrifluoroethylene, vinylidene fluoride, vinyl fluoride, a perfluoroalkyl vinyl ether (for example, perfluoromethyl vinyl ether, perfluoroethyl vinyl ether, and the like), hexafluoropropene, and the like.

The fluorine-based polymer having the constituent unit represented by formula (1) may be, for example, a copolymer of the abovementioned fluorine-based monomer and another monomer. In other words, the monomer group may include another monomer apart from the fluorine monomer.

The fluorine-based polymer having the constituent unit represented by formula (1) may be, for example, a copolymer of the abovementioned fluorine-based monomer and a vinyl-based monomer. Examples of vinyl-based monomers include alkenes such as ethylene and propylene; alkyl vinyl ethers such as ethyl vinyl ether and butyl vinyl ether; vinyl carboxylates such as vinyl acetate; and acrylic-based monomers such as (meth)acrylic acid and alkyl (meth)acrylate.

The fluorine-based polymer may be a polymer having a fluorinated alkyl (meth)acrylate unit as a monomer unit. An example of a fluorine-based polymer is one having the constituent unit represented by formula (2).

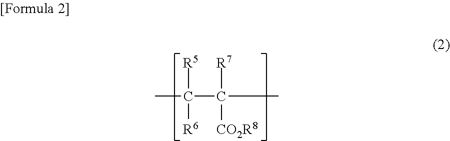

In the formula, R⁵, R⁶, and R⁷ each independently represents a hydrogen atom or an alkyl group, and R⁸ represents a fluorinated alkyl group.

In formula (2), a preferred alkyl group is an alkyl group having 1 to 6 carbon atoms, more preferably 1 to 3 carbon atoms, and still more preferably 1 or 2 carbon atoms. A fluorinated alkyl group is an alkyl group in which some or all of the hydrogen atoms are substituted by fluorine atoms. In formula (2), the fluorinated alkyl group preferably has 1 to 6 carbon atoms, and more preferably 1 to 3 carbon atoms.

R⁵ and R⁶ are preferably hydrogen atoms, and R⁷ is preferably a hydrogen atom or a methyl group.

The fluorine-based polymer may be a polymer of a monomer group including a fluorine-based monomer that forms the constituent unit represented by formula (2). Examples of fluorine-based monomers that form the constituent unit represented by formula (2) include trifluoromethyl (meth)acrylate, 2,2,3,3,4,4,4-heptafluorobutyl (meth)acrylate, 2,2,3,4,4,4-hexafluorobutyl (meth)acrylate, 2,2,3,3-tetrafluoropropyl (meth)acrylate, 1,1-dihydroperfluorocyclohexylmethyl (meth)acrylate, and the like.

The fluorine-based polymer having the constituent unit represented by formula (2) may be, for example, a copolymer of the abovementioned fluorine-based monomer and another monomer. In other words, the monomer group may include another monomer apart from the fluorine-based monomer.

The fluorine-based polymer having the constituent unit represented by formula (2) may be, for example, a copolymer of the abovementioned fluorine-based monomer and an acrylic-based monomer. Examples of acrylic-based monomers include (meth)acrylic acid, alkyl (meth)acrylate, and the like.

The fluorine-based polymer may include a constituent unit represented by the following formula (3).

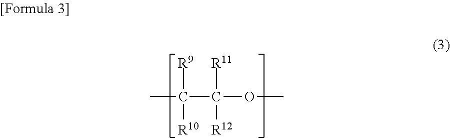

In the formula, R⁹, R¹⁰, R¹¹, and R¹² each independently represents a hydrogen atom, a fluorine atom, a chlorine atom, an alkyl group, a fluorinated alkyl group, an alkoxy group, or a fluorinated alkoxy group. At least one of R⁹, R¹⁰, R¹¹ and R¹² is a fluorine atom, a fluorinated alkyl group, or a fluorinated alkoxy group.

R⁹ and R¹⁰ are preferably a hydrogen atom or a fluorine atom, and R¹¹ and R¹² are preferably a hydrogen atom, a fluorine atom, an alkyl group, or a fluorinated alkyl group.

In formula (3), a preferred alkyl group is an alkyl group having 1 to 6 carbon atoms, more preferably 1 to 3 carbon atoms, and still more preferably 1 or 2 carbon atoms. A fluorinated alkyl group is an alkyl group in which some or all of the hydrogen atoms are substituted by fluorine atoms. In formula (3), the fluorinated alkyl group preferably has 1 to 6 carbon atoms, and more preferably 1 to 3 carbon atoms.

In formula (3), the alkoxy group is preferably an alkoxy group having 1 to 6 carbon atoms, and more preferably 1 to 3 carbon atoms. A fluorinated alkoxy group is an alkoxy group in which some or all of the hydrogen atoms are substituted by fluorine atoms. In formula (3), the fluorinated alkoxy group preferably has 1 to 6 carbon atoms, and more preferably 1 to 3 carbon atoms.

The fluorine-based polymer may be a polymer of a monomer group including a fluorine-based monomer that forms the constituent unit represented by formula (3). Examples of fluorine-based monomers that form the constituent unit represented by formula (3) include perfluoroethylene oxide, perfluoropropylene oxide, and the like.

The fluorine-based polymer having the constituent unit represented by formula (3) may be, for example, a copolymer of the abovementioned fluorine-based monomer and another monomer. In other words, the monomer group may include another monomer apart from the fluorine-based monomer.

The fluorine-based polymer having the constituent unit represented by formula (3) may be, for example, a copolymer of the abovementioned fluorine-based monomer and a diol-based monomer. Examples of diol-based monomers include ethylene oxide, propylene oxide, and the like.

The fluorine-based polymer may be a polymer having, for example, a cyclic ether skeleton. An example of such a fluorine-based polymer is one having the constituent unit represented by formula (4).

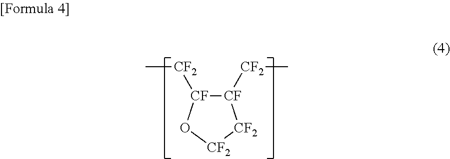

The number-average molecular weight of the fluorine-based polymer is preferably at least 5,000, and more preferably at least 10,000. Furthermore, the number-average molecular weight of the fluorine-based polymer is preferably no more than 20,000, and more preferably no more than 15,000.

The fluorine-based polymer preferably has a contact angle with water as measured according to the static drop method of JIS R 3257:1999 of at least 100°. Such a fluorine-based polymer will tend to have an especially low coefficient of friction.

The amount of fluorine-based polymer coating can be adjusted, as appropriate, according to the bundle diameter, bundle fiber count, and the like of the metal fiber bundle. For example, the amount of coating can be 1 part by mass or more per 100 parts by mass of the metal fiber bundle, or 3 parts by mass or more. Furthermore, the amount of coating may be 20 parts by mass or less per 100 parts by mass of the metal fiber bundle, or 15 parts by mass or less.

The metal fiber bundle coated with a fluorine-based polymer is cut into staple fiber bundles. The staple fiber bundle can be thought of as a fiber bundle obtained by bundling metal staple fibers. After cutting, the staple fiber bundle can be utilized in various applications either as-is or by unraveling the staple fiber bundle into metal staple fibers.

The average fiber length of the metal fiber bundle can be adjusted, as appropriate, according to the application. For example, the average fiber length of the metal fiber bundle may be 0.5 to 20 mm, or 1 to 10 mm.

### (Coating Step)

The manufacturing method according to the present embodiment may further include a coating step of obtaining a metal fiber bundle coated with a fluorine-based polymer.

The coating step may be, for example, a step of impregnating the metal fiber bundle with a coating fluid containing the fluorine-based polymer to coat the metal fiber bundle with the fluorine-based polymer.

The coating fluid contains a fluorine-based polymer and a solvent capable of dissolving the fluorine-based polymer. The solvent in the coating fluid can preferably be a fluorine-based solvent. The fluorine-based solvent can be selected, as appropriate, from among fluorine-based solvents capable of dissolving fluorine-based polymers.

The boiling point of the fluorine-based solvent is preferably 100° C. or less, and more preferably 80° C. or less. Impregnating the metal fiber bundle with such a fluorine-based solvent allows the fluorine-based solvent to be easily vaporized, and allows the coating step to be performed efficiently. The boiling point of the fluorine-based solvent is preferably at least 30° C., and more preferably at least 50° C. Such a fluorine-based solvent exhibits superior ease of handling under ordinary pressure, and thus can be expected to improve work efficiency.

Examples of the fluorine-based solvent include organic solvents, such as a hydrocarbon-based solvent, an ether-based solvent, an ester-based solvent, a ketone-based solvent, or a polyether-based solvent, some or all of the hydrogen atoms of which have been substituted by fluorine atoms.

Specific examples of the fluorine-based solvent include perfluorocarbons, hydrofluoroethers, perfluoroketones, perfluoropolyethers, hydrofluoroolefins, hydrofluorocarbons, and the like.

A commercially available fluorine-based solvent can be used as the fluorine-based solvent. Examples of commercially available fluorine-based solvents include Novec™ 7000, Novec™ 7100, Novec™ 7200, and Novec™ 7300 (all produced by 3M); Vertrel® XF, Vertrel® Sinera™, and Vertrel® Suprion™ (all produced by DuPont); GALDEN® SV80, GALDEN® SV110, GALDEN® HT80, GALDEN® HT110, and GALDEN® HT170 (all produced by Solvay Specialty Polymers); AK-225 and AE-3000 (both produced by Asahi Glass); CGS-4 (produced by Central Glass), and the like.

The fluorine-based polymer content of the coating fluid can be, for example, 1% by mass or more, and preferably 2% by mass or more. Furthermore, the fluorine-based polymer content of the coating fluid may be 20% by mass or less, and preferably 8% by mass or less.

A commercially available coating fluid can be used as the coating fluid. Examples of commercially available coating fluids include Novec™ 2702, Novec™ 1700, and Novec™ 1720 (all produced by 3M), Cytop S-type (produced by Asahi Glass), and the like.

In the coating step, for example, the metal fiber bundle can be impregnated with the coating fluid, followed by vaporizing the fluorine-based solvent to coat the metal fiber bundle with the fluorine-based polymer. At this time, the fluorine-based solvent may be vaporized at normal temperature and pressure, or under heating and/or a vacuum.

### (Removal Step)

The manufacturing method according to the present embodiment may further include a removal step of removing at least some of the fluorine-based polymer from the staple fiber bundles obtained in the cutting step.

In the removal step, the staple fiber bundles are unraveled by removing the fluorine-based polymer from the staple fiber bundles, which are formed into bundles by the fluorine-based polymer, thereby yielding independent metal staple fibers.

In the removal step, for example, at least some of the fluorine-based polymer coating the staple fiber bundles can be dissolved and removed using a fluorine-based solvent.

The fluorine-based solvent is preferably the same fluorine-based solvent used in the coating step.

In the removal step of the present embodiment, it is not necessary to remove all of the fluorine-based polymer; only enough need be removed to allow the staple fiber bundles to unravel. The removal step may be, for example, a step of removing some of the fluorine-based polymer to obtain metal staple fibers coated by the remainder of the fluorine-based polymer.

The removal step can be performed, for example, by immersing the staple fiber bundles obtained in the cutting step in the fluorine-based solvent so that the fluorine-based solvent dissolves at least some of the fluorine-based polymer. Such a method allows the removal step to be performed without placing a mechanical load upon the metal staple fibers, yielding more uniform metal staple fibers.

The fluorine-based polymer removed in the removal step can be reused in the coating step.

If, for example, the removal step is performed using a fluorine-based solvent, the fluorine-based solvent in which the fluorine-based polymer is dissolved is recovered. The fluorine-based polymer concentration of the recovered liquid can be adjusted by removing fluorine-based solvent or adding fluorine-based polymer so that the fluid can be reused as coating fluid in the coating step.

### (Metal Staple Fibers)

Metal staple fibers manufactured via the manufacturing method according to the present embodiment exhibit suppressed collapsing of the metal fiber bundle during cutting, thus yielding uniform short fibers.

The metal staple fibers can be used in the form of the staple fiber bundles obtained in the cutting step, or in the form of an unraveled group of staple fibers obtained in the removal step. Some or all of the metal staple fibers may be coated by a fluorine-based polymer.

Examples of uses for the metal staple fibers include filling a resin composition so as to impart the resin composition with properties such as electromagnetic shielding properties and antistatic properties, or to increase the mechanical strength of the resin composition.

### (Apparatus for Manufacturing Metal Staple Fibers)

A preferred embodiment of a manufacturing apparatus for implementing the manufacturing method described above will now be described.

The manufacturing apparatus according to the present embodiment is provided with a coating mechanism for coating a metal fiber bundle with a fluorine-based polymer, and a cutting mechanism for cutting the metal fiber bundle coated with the fluorine-based polymer into staple fiber bundles.

The coating mechanism may include, for example, a coating tank for storing a coating fluid containing the fluorine-based polymer, and a conveying means for passing the metal fiber bundle through the coating tank so that the coating fluid impregnates the metal fiber bundle.

The coating mechanism may be, for example, a mechanism having a discharge unit for discharging coating fluid and which performs coating by bringing coating fluid discharged from the discharge unit into contact with the metal fiber bundle.

The cutting mechanism may be a mechanism including, for example, a supporting part for supporting the metal fiber bundle and a cutting unit having a cutting blade for cutting the metal fiber bundle supported by the supporting part.

The manufacturing apparatus according to the present embodiment may be further provided with a removal mechanism for removing at least some of the fluorine-based polymer from the staple fiber bundle cut by the cutting mechanism.

The removal mechanism may be, for example, a mechanism that uses a fluorine-based solvent to dissolve and remove the fluorine-based polymer coating the staple fiber bundle.

The removal mechanism may include a removal tank for storing fluorine-based solvent and a recovery means for recovering metal staple fibers from the removal tank. Such a removal mechanism allows for easy removal of the fluorine-based polymer by immersing the staple fiber bundles in the fluorine-based solvent. The recovery means may be, for example, a recovery means that lifts metal staple fibers out of the removal tank, or a recovery means that drains the fluorine-based solvent from the removal tank and recovers the metal staple fibers remaining in the removal tank.

The removal mechanism may be, for example, a mechanism that includes a discharge unit for discharging fluorine-based solvent and removes the fluorine-based polymer by bringing the staple fiber bundles into contact with the fluorine-based solvent discharged from the discharge unit.

The manufacturing apparatus according to the present embodiment may be further provided with a recovery mechanism for recovering the fluorine-based polymer removed by the removal mechanism.

For example, the recovery mechanism, recovers the fluorine-based solvent containing the fluorine-based polymer as recovered liquid. The recovery mechanism can be configured so as to be capable of vaporizing some of the fluorine-based solvent in the recovered liquid for reuse as coating fluid.

A preferred embodiment of the manufacturing apparatus according to the present invention will now be described with reference to the drawings

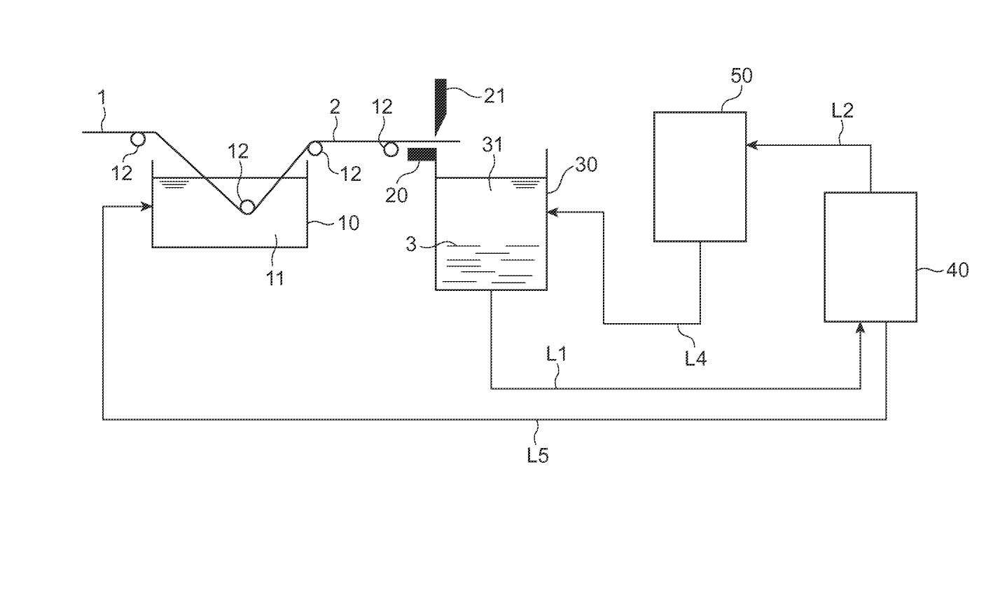

FIG. 1 is a schematic illustration of a preferred embodiment of a manufacturing apparatus according to the present invention. FIG. 1 is merely a schematic illustration of various elements for the purposes of describing the embodiment, and the dimensional ratios and positional relationships of the elements are not limited to those shown in the drawing. Furthermore, the manufacturing apparatus according to the present invention is not limited to the embodiment described hereafter.

The manufacturing apparatus 100 includes a coating tank 10 for storing a coating fluid 11 containing a fluorine-based polymer, a plurality of conveyor rollers 12 for conveying a metal fiber bundle 1 so as to pass through the coating tank, a supporting part 20 for supporting a coated metal fiber bundle 2, a cutting unit 21 for cutting the metal fiber bundle 2 supported by the supporting part 20 into staple fiber bundles, a removal tank 30 for storing a fluorine-based solvent 31 for removing the fluorine-based polymer from a staple fiber bundle 3 cut by the cutting unit 21, a recovery line L1 for recovering the fluorine-based solvent from the removal tank 30 after removal of the fluorine-based polymer, a distillation column 40 for distilling recovered liquid delivered from the recovery line L1, a recovery line L2 for recovering vaporized fluorine-based solvent from the top of the distillation column 40, a condensation tank 50 for condensing fluorine-based solvent recovered from the distillation column 40, a fluid delivery line L4 for delivering the fluorine-based solvent stored in the condensation tank 50 to the removal tank, and a fluid delivery line L5 for delivering concentrated recovered liquid from the bottom of the distillation column 40 to the coating tank 10.

The coating tank 10 of the manufacturing apparatus 100 is a tank for storing the coating fluid 11 containing the fluorine-based polymer. The conveyor rollers 12 are constituted by a plurality of rollers for conveying the metal fiber bundle 1, and convey the metal fiber bundle 1 so as to pass through the coating fluid 11 in the coating tank 10.

The metal fiber bundle 1 passing through the coating fluid 11 is impregnated with coating fluid, and the solvent in the coating fluid vaporizes during subsequent conveying, thereby coating the fibers with the fluorine-based polymer.

The coated metal fiber bundle 2 is conveyed upon the supporting part 20, and is cut by the cutting unit 21 into staple fiber bundles. The staple fiber bundle 3 cut by the cutting unit 21 falls into the removal tank 30 disposed beneath the cutting unit, and the fluorine-based polymer is dissolved by the fluorine-based solvent 31 in the removal tank 30.

After the fluorine-based polymer has been dissolved, the staple fiber bundle 3 (or unraveled metal fiber bundle) is recovered as product. The fluorine-based solvent in which the fluorine-based polymer is dissolved is delivered from the recovery line L1 to the distillation column 40 as recovered liquid.

In the distillation column 40, some of the fluorine-based solvent in the recovered liquid is dissolved away to concentrate the recovered liquid. The concentrated recovered liquid is delivered through the fluid delivery line L5 to the coating tank 10, and reused as the coating fluid 11.

The fluorine-based solvent distilled away in the distillation column 40 is sent in gaseous form through the recovery line L2 to the condensation tank 50, and is condensed into a liquid at the condensation tank 50. The condensation tank 50 stores the fluorine-based solvent, and supplies the fluorine-based solvent to the removal tank 30 through the fluid delivery line L4 as necessary.

In accordance with the manufacturing apparatus 100, the preferred manufacturing method described above can easily be implemented, allowing for the efficient manufacture of uniform metal staple fibers.

### (Confirmation Tests)

Tests for confirming the manufacturing method according to the present embodiment were performed.

### <Confirmation Test 1>

The following confirmation test was performed using a fiber bundle (diameter=3 mm) of #0000 (diameter=0.012 mm) steel wool as the metal fiber bundle, Novec™ 1700 (fluorine-based polymer content: 2% by mass; produced by 3M) as the coating fluid, and Novec™ 7100 (hydrofluoroether; boiling point: 61° C.; produced by 3M) as the fluorine-based solvent.

The metal fiber bundle was immersed for ten seconds in the coating fluid, and then dried to coat the metal fiber bundle in the fluorine-based polymer. Next, the coated metal fiber bundle was cut into staple fiber bundles having fiber lengths of 3 mm. The staple fiber bundle was immersed for one minute in the fluorine-based solvent to dissolve the fluorine-based polymer and unravel the staple fiber bundle, and metal staple fibers were thereby obtained.

### <Confirmation Test 2>

Metal staple fibers were obtained as in confirmation test 1, except that Novec™ 1700 concentrated to a fluorine-based polymer content of 8% by mass was used as the coating fluid.

### <Confirmation Test 3>

A staple fiber bundle was obtained as in confirmation test 1, except that Novec™ 1700 concentrated to a fluorine-based polymer content of 20% by mass was used as the coating fluid. The staple fiber bundle was immersed for two minutes in the fluorine-based solvent to dissolve the fluorine-based polymer and unravel the staple fiber bundle, and metal staple fibers were thereby obtained.

### <Comparison Test 1>

The metal fiber bundle obtained in confirmation test 1 was cut without first being coated. The fiber bundle readily collapsed during cutting, leading to non-uniform cutting.

In confirmation tests 1 to 3, collapse of the metal fiber bundles was suppressed, and uniformly cut short fibers were obtained. In the manufacturing method according to the present embodiment, the metal fiber bundle is coated with a fluorine-based polymer, thereby yielding a low amount of friction during cutting compared, for example, to the metal fiber bundle coated with a styrene-based resin disclosed in patent document 1, and thus will presumably yield uniform staple fibers exhibiting little end warpage.

The foregoing has been a description of a preferred embodiment of the present invention, but the present invention is not limited to the embodiment described above.

For example, one aspect of the present invention may relate to metal staple fibers manufactured according to the manufacturing method described above. Another aspect of the present invention can relate to a method of suppressing collapse in a metal fiber bundle during cutting by coating the metal fiber bundle with a fluorine-based polymer before cutting.
1: Metal fiber bundle
2: Coated metal fiber bundle
3: Staple fiber bundle
10: Coating tank
11: Coating fluid
12: Conveyor roller
20: Supporting part
21: Cutting unit
30: Removal tank
31: Fluorine-based solvent
40: Distillation column
50: Condensation tank

1. A method for manufacturing metal staple fibers, the method thereof comprising a cutting step of cutting a metal fiber bundle coated with a fluorine-based polymer into a staple fiber bundle, further including a removal step of using a fluorine-based solvent to dissolve and remove at least some of the fluorine-based polymer coating the staple fiber bundle.

2. The manufacturing method according to claim 1, wherein the fluorine-based polymer has a fluorine atom content of at least 40% by mass with respect to the total mass of the fluorine-based polymer.

3. The manufacturing method according to claim 1, further including a coating step of impregnating a metal fiber bundle with a coating fluid containing the fluorine-based polymer to coat the metal fiber bundle in the fluorine-based polymer.

4. (canceled)

5. The manufacturing method according to claim 1, wherein some or all of the fluorine-based polymer removed in the removal step is reused to coat the metal fiber bundle.

6. An apparatus for manufacturing metal staple fibers provided with:
a coating mechanism for coating a metal fiber bundle with a fluorine-based polymer; and
a cutting mechanism for cutting the metal fiber bundle coated with the fluorine-based polymer into staple fiber bundles.

7. The manufacturing apparatus according to claim 5, wherein the coating mechanism comprises:
a coating tank for storing a coating fluid containing the fluorine-based polymer; and
a conveying means for passing the metal fiber bundle through the coating tank so that the metal fiber bundle is impregnated with the coating fluid.

8. The manufacturing apparatus according to claim 5, further provided with a removal mechanism that uses a fluorine-based solvent to dissolve and remove at least some of the fluorine-based polymer coating the staple fiber bundle.

9. The manufacturing apparatus according to claim 7, wherein the removal mechanism dissolves at least some of the fluorine-based polymer by immersing the staple fiber bundle in the fluorine-based solvent.

10. The manufacturing apparatus according to claim 7, further provided with a recovery mechanism for recovering the fluorine-based polymer removed by the removal mechanism.
